(19) United States
(12) Patent Application Publication
(10) Pub. No.: US 2011/0113437 A1
(43) Pub. Date: May 12, 2011

(54) METHOD AND SYSTEM FOR MEDIA DISC LOSS PREVENTION

(75) Inventor: Alan Day, Pembroke Pines, FL (US)

(73) Assignee: SENSORMATIC ELECTRONICS CORPORATION, Boca Raton, FL (US)

(21) Appl. No.: 12/615,582

(22) Filed: Nov. 10, 2009

(51) Int. Cl. G11B 23/03

(52) U.S. Cl. 720/728; 340/568.1

(57) ABSTRACT

An apparatus, system and method discourage theft of a media disc. The media disc has a central aperture and is retained within a media disc case by an inner spindle that extends through the central aperture. A pin is insertable through the inner spindle. A locking clutch is operable to engage the pin. When engaged, the locking clutch secures the media disc upon the inner spindle and prevents the media disc from being removed from the inner spindle. A liquid-dispensing container is positioned between the pin and the media disc such that when a force is exerted upon the media disc to attempt to remove the disc from the inner spindle when the locking clutch is engaged, the liquid-dispensing container releases a liquid which renders the media disc unreadable.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates generally to a method and system for discouraging media disc theft and more specifically to a method and system for denying the benefit of use of a media disc to a thief by preventing the disc from being removed from its packaging without damaging the disc.

### BACKGROUND OF THE INVENTION

Media discs, such as compact discs (“CD”) and digital video discs (“DVD”) containing music and other audio, movies and other video, computer programs, video games, and other such data, have long been the target of theft due to the desirability of owning the content of the disc versus the cost of the disc. Additionally, as these discs are relatively small in size, thieves may easily hide these items in a garment or shopping bag and simply walk out of a store undetected.

Others have tried to protect disc media from theft by placing mechanical locks on the media disc cases or as a keeper around the outside of these cases. These mechanical locks are usually bulky, taking up precious retail shelf space. Additionally, the lock discourages consumers from picking up the DVDs, CD, or games, negatively affecting the sales of the merchandise. Some retailers simply lock the most expensive discs in cases and do not allow the customer any access to the discs without assistance from authorized personnel, thereby inhibiting possible legitimate sales because of mere inconvenience.

Another approach is to place electronic article surveillance (“EAS”) markers or labels within the cases. The EAS labels are designed to activate an alarm at the store entrance when an unpurchased disc is carried through EAS detection pedestals located near store entrances. However, these alarms are often ignored due to excessive false alarms, generally caused by inexperienced or improperly trained employees failing to properly deactivate all EAS labels upon purchase. Additionally, thieves may sneak detection obstructing devices, such as metal-shielded objects, into the store for the express purpose of defeating the EAS alarm. The metal shield shields the EAS marker from interrogation signals at the pedestals. Thus, small objects such as media discs that can readily be placed inside the shielding are often targeted and successfully stolen.

Another approach is the use of optical shutter to block the read of the directory of the media disc rendering the disc unreadable. Upon purchase or proper check out, the material is subject to a current to turn the material transparent and the disc usable. However, the equipment to employ the optical shutter concept is very expensive and the material is quite exotic, thereby prohibiting most disc manufacturers and retailers from implementing this solution.

Even with these theft prevention and detection methods, shoplifters come up with novel ways to break through these deterrents and steal discs because the value of the disc means more to the thief than the cost of breaking theft prevention barriers. In other words, as soon as the disc is stolen, the thief can freely use the contents.

Therefore, what is needed is a system and method for discouraging media disc theft by denying the benefit of use to the thief.

### SUMMARY OF THE INVENTION

The present invention advantageously provides a method, apparatus and system for discouraging media disc theft by denying the benefit of use to the thief. Generally, a theft-prevention apparatus is attached to the media disc case which prevents the thief from removing the media disc from the media disc case without damaging the actual disc. In one embodiment, upon an attempted forcible removal, a liquid-dispensing container is broken, releasing a liquid upon the media disc which renders the disc unreadable.

In accordance with one aspect of the present invention, an apparatus for discouraging theft of a media disc is provided. The media disc defines a central aperture and is retainable within a media disc case by an inner spindle extending through the central aperture. The apparatus includes a pin and a locking clutch. The pin is insertable through the inner spindle. The locking clutch is operable to engage the pin. When engaged, the locking clutch secures the media disc upon the inner spindle and prevents the media disc from being removed from the inner spindle.

In accordance with another aspect of the present invention, a system is provided for discouraging theft of a media disc having a central aperture. The system includes a media disc case, a pin and a locking clutch. The media disc case is operable to retain the media disc on an inner spindle extending through the central aperture. The pin is insertable through the inner spindle. The locking clutch is operable to engage the pin. When engaged, the locking clutch secures the media disc upon the inner spindle and prevents the media disc from being removed from the inner spindle.

In accordance with yet another aspect of the present invention, a method of discouraging theft of a media disc is provided. The media disc has a central aperture and is retained within a media disc case by an inner spindle extending through the central aperture. A pin of a theft-deterring apparatus is inserted through the inner spindle. The media disc is secured upon the inner spindle by engaging the pin within a locking clutch. The locking clutch prevents the media disc from being removed from the inner spindle.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a front view of the inside of an exemplary media disc case including a tamper-resistant ink pin constructed in accordance with the principles of the present invention;

FIG. 2 is a cross sectional view of the media disc case of FIG. 1 assembled with a tamper-resistant ink pin constructed in accordance with the principles of the present invention;

FIG. 3 is a is a cross sectional view of the media disc case of FIG. 1 with the tamper-resistant ink pin removed in accordance with the principles of the present invention;

FIG. 4 is an exploded view of an exemplary tamper-resistant ink pin constructed in accordance with the principles of the present invention;

FIG. 5 is a detailed cross-sectional view of the spindle area of the media disc case of FIG. 1 assembled with the tamper-resistant ink pin in accordance with the principles of the present invention;

FIG. 6 is a perspective view of the media disc case of FIG. 1 constructed in accordance with the principles of the present invention;

FIG. 7 is a rear view of the outside of an alternative media disc case having a discrete pin and ink vial constructed in accordance with the principles of the present invention;

FIG. 8 is a front view of the inside of an alternative media disc case having a locking clutch integrated into the case spindle, constructed in accordance with the principles of the present invention;

FIG. 9 is a front view of the outside of an alternative media disc case having the locking clutch outside the case, constructed in accordance with the principles of the present invention; and

FIG. 10 is a front view of the outside of an alternative media disc case having the locking clutch as part of an EAS hard tag and located on the outside of the case, constructed in accordance with the principles of the present invention.

### DETAILED DESCRIPTION OF THE INVENTION

Before describing in detail exemplary embodiments that are in accordance with the present invention, it is noted that the embodiments reside primarily in combinations of apparatus components and processing steps related to implementing a system and method for discouraging media disc theft by denying the benefit of use to a potential thief. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

One embodiment of the present invention advantageously provides a method and system for discouraging theft of media discs by preventing the disc from being removed from the case without permanently damaging the disc, thereby rendering the disc useless. In one embodiment, a magnetic locking clutch secures the disc within the case using a tamper-resistant ink-filled pin. If the magnetic locking clutch is not properly disengaged and the ink-filled pin properly removed by personnel at the point of sale, a vial in the ink-filled pin breaks upon attempted removal, spilling a permanent ink on the readable portion of the disc and rendering the disc unreadable.

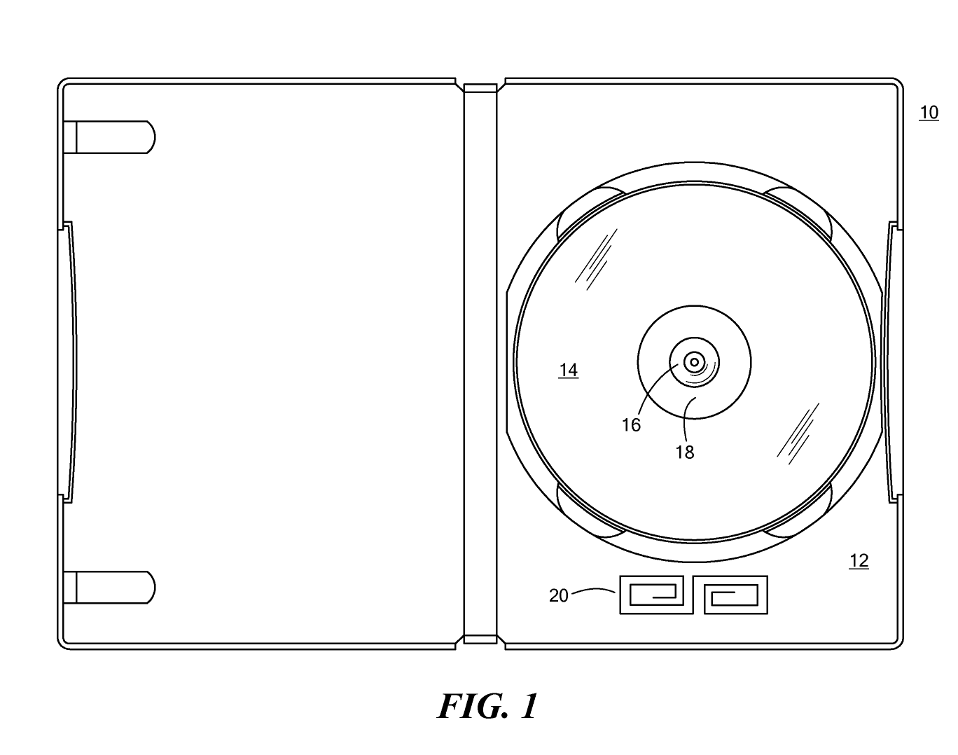

Referring now to the drawing figures in which like reference designators refer to like elements, there is shown in FIG. 1 one configuration of an exemplary media disc theft deterrent system 10 constructed in accordance with the principles of the present invention. The theft deterrent system 10 includes a media disc case 12 which houses or encloses a media disc 14 upon an inner spindle. An exemplary media disc case 12 may include a standard digital video disc (“DVD”) case or compact disc (“CD”) jewel case. The media disc 14 is secured to the inner spindle by a locking clutch 16 which engages a pin (not shown) inserted through the back cover of the media disc case 12. The locking clutch 16 may be a standard magnetic locking mechanism such as those commonly used in electronic article surveillance (“EAS”) hard tags. The locking clutch 16 may be only removed from the pin using a detacher, such as a magnetic detacher. In some embodiments, the locking clutch 16 remains inside the case even after being detached from the pin. In other embodiments, the locking clutch 16 is exterior to the case and can be discarded or re-used after removal. Any attempt to forcibly remove the media disc 14 from the media disc case 12 prior to removing the locking clutch permanently damages the media disc 14. The force is either sufficient to break the disc, render the media disc 14 unreadable by separating the transparent plastic outer layer of the media disc 14 from the protected silicon underneath, or break a liquid-dispensing vial releasing a permanent marking solution, such as ink, dye, paint, glue or any other viscous substance that will permanently damage the media disc 14. It is also contemplated that a suitable permanent marking liquid can include a mixture of Methyl Isobutyl Ketone, Butyl Acetate, and a resin. Such a marking liquid mixture is resistant to removal using alcohol and other known removers. The liquid-dispensing mechanism is discussed in greater detail below.

An optional removal protection ring 18 may be inserted between the locking clutch 16 and the media disc 14 to further hinder tampering. Additionally, an EAS label 20 may be included inside the media disc case 12 which triggers an alarm if not deactivated prior to entering an interrogation zone of an EAS system as is commonly known in the art. It should be noted that in this configuration, the EAS label 20, the locking mechanism 16 and the removal protection ring 18 are assembled by the manufacturer as part of a packaging process.

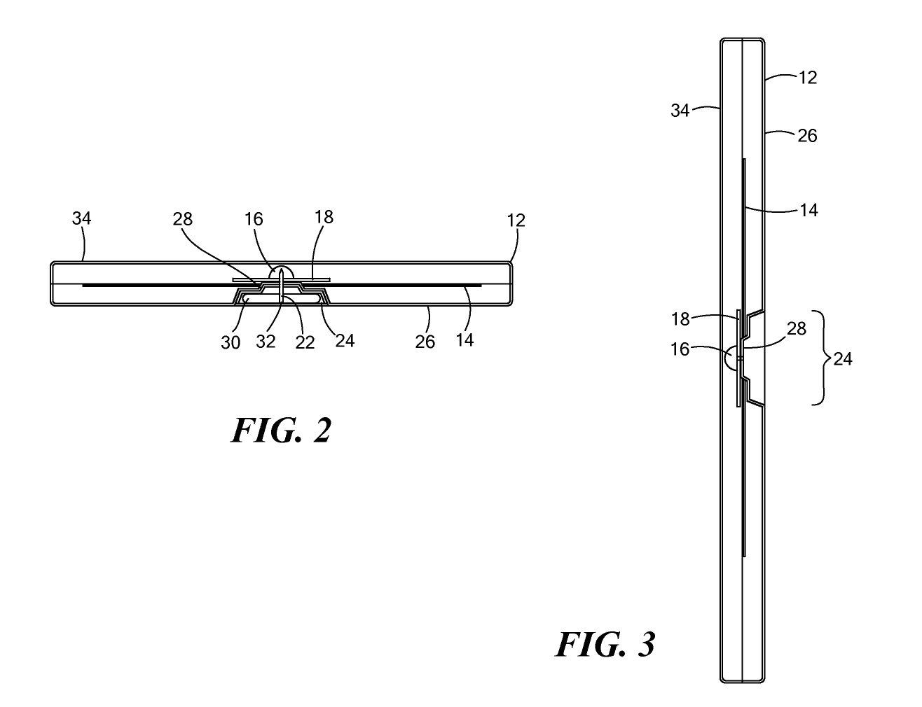

Referring now to FIG. 2, a cross sectional view of an exemplary media disc theft deterrent system 10 is provided. The system 10 includes a media disc case 12 having a pin 22 secured by a locking clutch 16 and removal protection ring 18. The media disc case 12, as is typical among commonly used media disc cases, includes an indented area 24 in the back cover 26 which forms a spindle 28 inside the media disc case 12. The media disc 14 is retained in the case 12 by placing the central opening of the disc 14 over the inner spindle 28. Small tabs (not shown) along the perimeter of the spindle 28 compress inwardly when the disc 14 is placed over the spindle 28 and expand outwardly over the edge of the central opening as the disc 14 is pressed downward (toward the back cover 26) capturing the disc 14 in place. To allow for movement of the tabs, small openings are cut or molded between the tabs and may extend through the back cover 26.

A liquid-dispensing container 30, such as an ink tag, is inserted into the indented area 24 of the back cover 26 on the outside the media disc case 12. The pin 22 extends through the back cover 26 and the central opening of the media disc 14. The locking clutch 16 captures the pin 22 on top of the media disc 14 inside the case 12. The liquid-dispensing container 30 may be integrated within the head 32 of the pin 22. Attempts to remove the media disc 14 without unlocking the locking clutch 16 rupture the liquid-dispensing container 30, spilling the contained liquid, which flows through the openings on the back cover 26 and onto the media disc 14, thereby rendering the disc 14 unreadable.

Advantageously, an embodiment of the present invention provides benefit denial for the media disc market in a way that does not add any unwanted thickness to the media disc case 12. This allows the cases 12 to be placed directly on store shelves and occupy a minimal amount of shelf space. In this embodiment, the locking clutch 16 and removal protection ring 18 are inside the media disc case 12. These components are assembled during packaging and the pin 22 and liquid-dispensing container 30 are on the outside of the media disc case 14. When passed over a detacher with a high enough magnetic field, the locking clutch 16 releases the pin 22 and the liquid-dispensing container 30 may be detached. The magnetic locking clutch 16 remains inside the case 12. This arrangement ensures that the consumer does not take home an ink vial which can later fracture and harm the consumer or damage the product unintentionally.

Since a media disc case 12, such as a DVD case, offers spaces as small as 0.6 cm between the media disc 14 and the front cover 34 of the case 12, the height of the locking clutch 16 is an important consideration as the locking clutch 16 should fit comfortably between the media disc and the front cover 34 without interfering with or distorting the case 12. Appropriate ink or other liquid that attacks the surface of the media disc 12 provides benefit denial to a potential thief and helps to deter theft.

Referring now to FIG. 3, a cross sectional view of an exemplary media disc case 14 is provided. The back cover 26 includes an indented area 24 which forms the inner spindle 28. The pin 22 and liquid-dispensing container 30 reside within the indented area 24 on the outside of the media disc case 12.

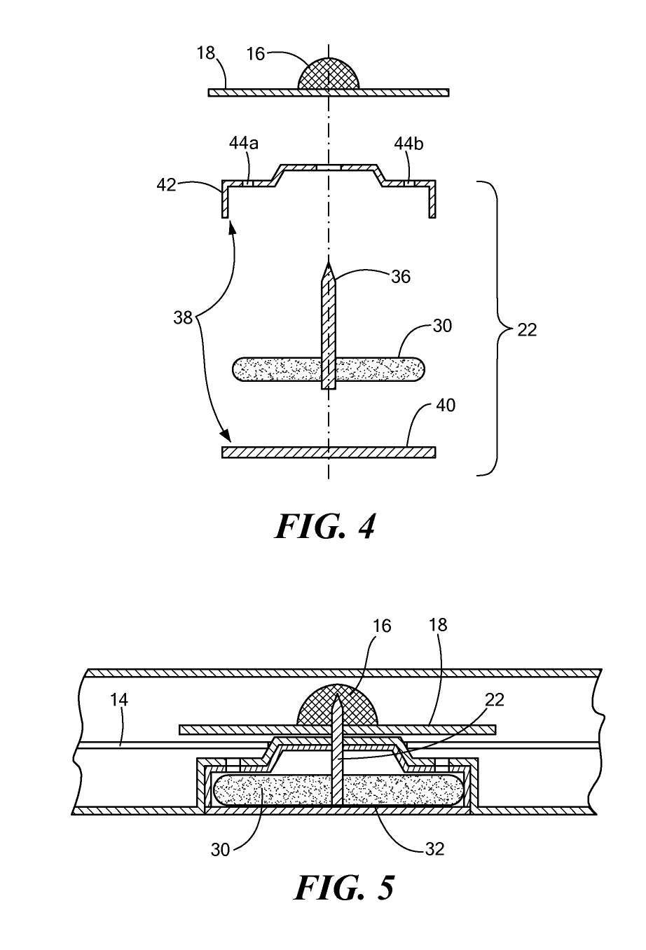

Referring now to FIG. 4, an exploded view of a pin 22 having an integrated liquid-dispensing container 30 is provided. The pin 22 has the integrated liquid-dispensing container 30, a shaft portion 36 and an enclosed head 38. Head 38 has a bottom portion 40 and a top portion 42. When assembled, the bottom portion 40 and the top portion 42 create a cavity in which the liquid-dispensing container 30 is placed. The top portion includes several openings 44a, 44b (two shown) through which the liquid contained within the liquid-dispensing container 30 may flow. The enclosed head 38 is formed from a malleable material which allows the head 38 to flex enough to break the liquid-dispensing container 30 when a forcible removal is attempted. Another suitable embodiment provides a solid plastic component which elevates the ends of the liquid-dispensing container 30 above the surface of the case. Pulling on the center of the liquid-dispensing container 30 by the attached shaft 36 causes the liquid-dispensing container to “bend” into the cavity, causing the liquid-dispensing container 30 to shatter. The enclosed head 38 allows easy removal of the pin 22 without requiring store personnel to track a separate pin and liquid-dispensing container and provides a certain degree of protection for the liquid-dispensing container 30 when not attached to the media disc case 12.

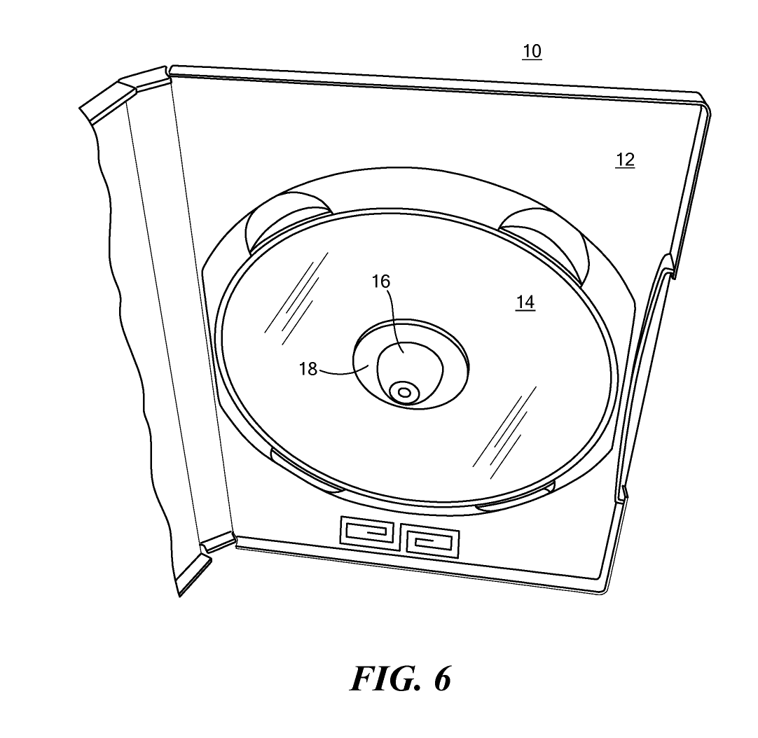

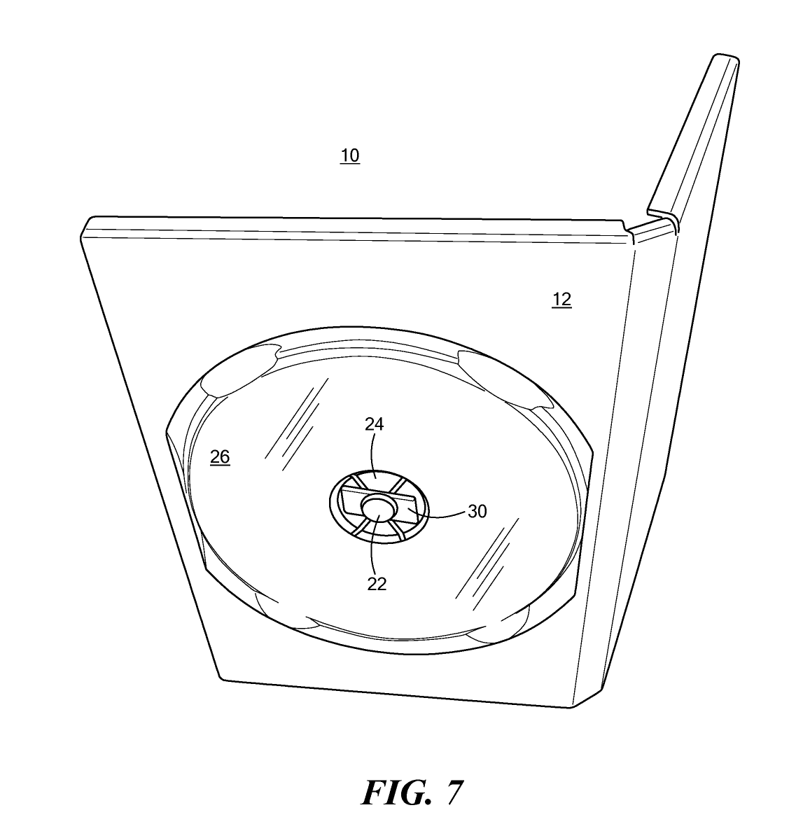

FIG. 5 provides a close-up cross-sectional view of the pin 22 and locking clutch 16 when assembled. It should be noted that the assembled theft deterrent device does not add excess thickness to the overall thickness of the media disc case 12. FIG. 6 is a perspective view of an exemplary media disc case 12 securing a media disc 14 with a theft deterrent device as discussed above with reference to FIGS. 1-5.

Referring now to FIG. 7, a perspective view of the back cover 26 of an alternative embodiment of the present invention is provided. In accordance with this embodiment, the pin 22 has a solid head 46 and the liquid-dispensing container 30 is separate and independent from the pin 22. The liquid-dispensing container 30, in this embodiment, includes a small aperture or other opening through which the shaft 36 of the pin 22 may pass. Although the liquid-dispensing container 30 is shown as a thin, flat rectangular vial, the actual geometric shape of the liquid-dispensing container 30 is not limited by the present invention. However, it is desirable for the liquid-dispensing container 30 and the pin 22 to fit within the inverted area 24 of the back cover 26 in order to preserve the original thickness of the media disc case 12.

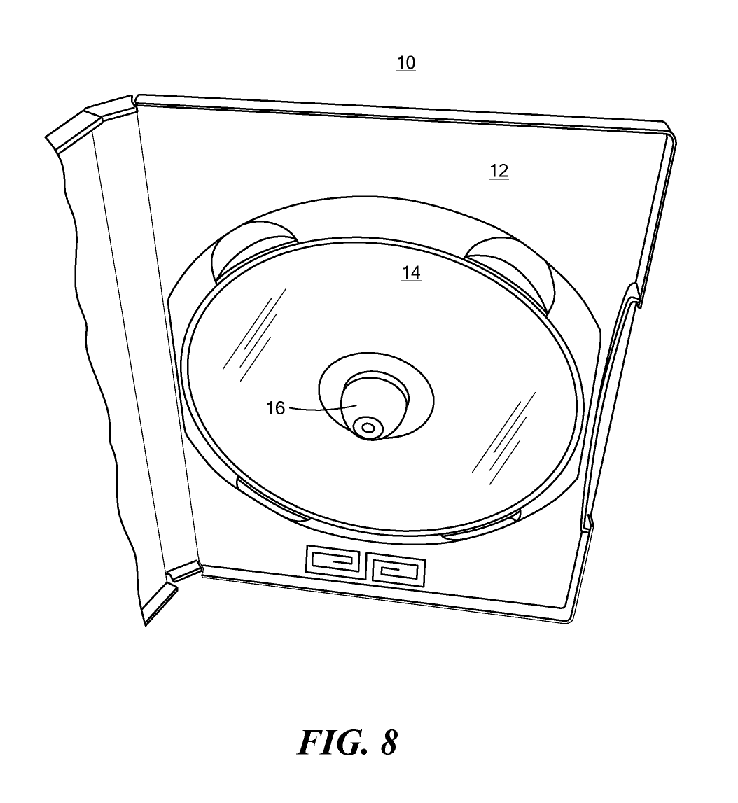

Referring now to FIG. 8, a front view of the media disc case 12 in an open position is provided in accordance with an alternative embodiment of the present invention. In this embodiment, the locking clutch 16 is integrated into the inner spindle 28 of the media disc case 12. The locking clutch 16 is designed such that the central opening of the media disc 14 fits snugly is retained snugly by the locking clutch 16 in a compression fit, but may be removed by exerting an upward (away from the back cover 26) pressure on the media disc 14 which may be slightly greater than that required to remove a disc 14 from a standard media disc case. Thus, if a liquid-dispensing container 30 is present and secured by the locking clutch 16, the liquid-dispensing container 30 will break in the same manner as described above in relation to the theft deterrent system 10 of FIGS. 1-6. Although potentially not as secure as the above embodiment, this embodiment allows attachment of the theft deterrent device at either the manufacturer or at the point of sale. Additionally, when the liquid-dispensing container 30 is removed, the locking clutch 16 is not able to roll around loose in the media disc case 12, potentially damaging the media disc.

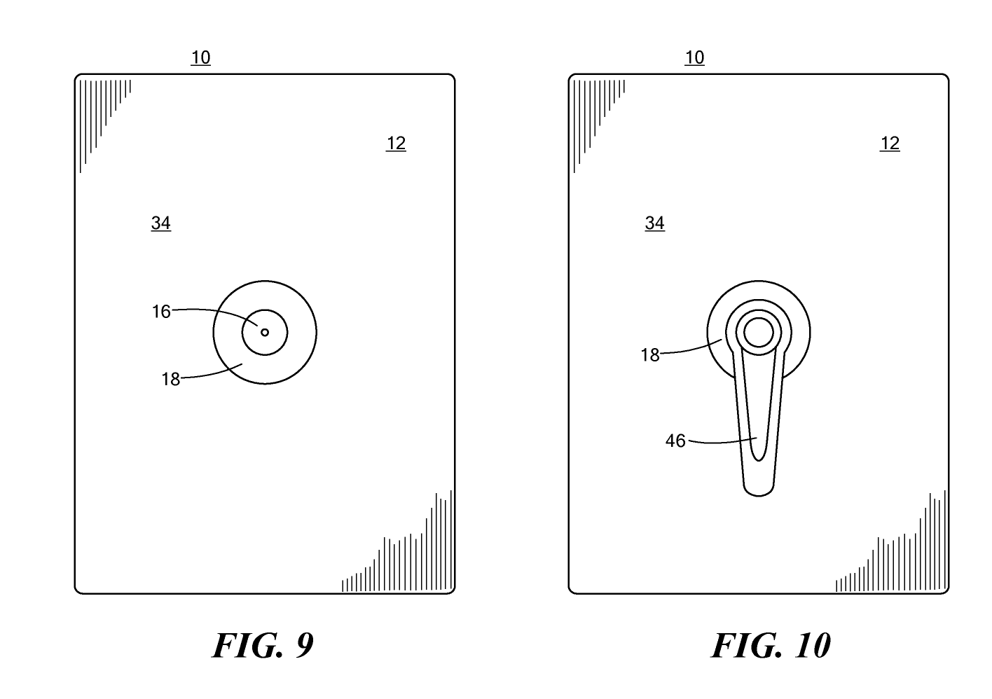

Referring now to FIGS. 9 and 10, an alternative embodiment of the present is provided wherein the locking clutch 16 and optional removal prevention disk 18 are assembled on the outside of the media disc case 12. In this embodiment, the pin 22 extends through the inner spindle 28 as well as the front cover 34, and engages the locking clutch 16 against the front cover 34. The locking clutch 16 may be a single independent device, as shown in FIG. 9, or may be integrated into a standard EAS hard tag 46. The media disc case 12 cannot be opened without first removing the locking clutch 16 and liquid-dispensing container 30. In FIG. 10, the magnetic locking clutch 16 of a standard EAS hard tag secures the pin 22. This embodiment advantageously allows a retailer to easily attach the theft deterrent device to a media disc case 12, but adds excess thickness and bulk to the media disc case 12 making storage more difficult and requiring additional shelf space.

Unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. An apparatus for discouraging theft of a media disc, the media disc defining a central aperture, the media disc retainable within a media disc case by an inner spindle extending through the central aperture, the apparatus comprising:
a pin insertable through the inner spindle;
a locking clutch operable to engage the pin, and when engaged, the locking clutch:
secures the media disc upon the inner spindle; and
prevents the media disc from being removed from the inner spindle.

2. The apparatus of claim 1, further comprising a liquid-dispensing container positioned between the pin and the media disc such that when a force is exerted upon the media disc to attempt to remove the disc from the inner spindle when the locking clutch is engaged, the liquid-dispensing container releases a liquid material.

3. The apparatus of claim 2, wherein the liquid is at least one of permanent ink, dye, paint and glue.

4. The apparatus of claim 2, wherein the liquid-dispensing container is part of the pin.

5. The apparatus of claim 1, wherein the media disc case includes a front cover and a back cover, and wherein the locking clutch has a height small enough to allow positioning between the media disc and the front cover when the media disc case is in a closed position.

6. The apparatus of claim 1, wherein the locking clutch is part of the inner spindle.

7. The apparatus of claim 1, wherein the media disc case includes a front cover and a back cover, and wherein the pin extends through the back cover and through the front cover when the media disc case is in a closed position.

8. The apparatus of claim 1, wherein the locking clutch is at least one of an electronic article surveillance (“EAS”) hard tag and a magnetically removable clutch.

9. A system for discouraging theft of a media disc having a central aperture, the system comprising:
a media disc case operable to retain the media disc on an inner spindle extending through the central aperture;
a pin insertable through the inner spindle; and
a locking clutch operable to engage the pin, and when engaged, the locking clutch:
secures the media disc upon the inner spindle; and
prevents the media disc from being removed from the inner spindle.

10. The system of claim 9, further comprising a liquid-dispensing container positioned between the pin and the media disc such that when a force is exerted upon the media disc to attempt to remove the disc from the inner spindle when the locking clutch is engaged, the liquid-dispensing container releases a liquid.

11. The system of claim 10, wherein the liquid is at least one of permanent ink, dye, paint and glue.

12. The system of claim 10, wherein the liquid-dispensing container is part of the pin.

13. The system of claim 9, wherein the media disc case includes a front cover and a back cover, and wherein the locking clutch has a height small enough to allow positioning between the media disc and the front cover when the media disc case is in a closed position.

14. The system of claim 9, wherein the locking clutch is part of the inner spindle.

15. The system of claim 9, wherein the media disc case includes a front cover and a back cover, and wherein the pin extends through the back cover and through the front cover when the media disc case is in a closed position.

16. The system of claim 9, wherein the locking mechanism is at least one of an electronic article surveillance (“EAS”) hard tag and a magnetically removable clutch.

17. A method of discouraging theft of a media disc, the media disc having a central aperture, the media disc retained within a media disc case by an inner spindle extending through the central aperture, the method comprising:
inserting a pin of a theft-deterring apparatus through the inner spindle; and
securing the media disc upon the inner spindle by engaging the pin within a locking clutch, the locking clutch preventing the media disc from being removed from the inner spindle.

18. The method of claim 17, further comprising positioning a liquid-dispensing container between the pin and the media disc such that when a force is exerted upon the media disc to attempt to remove the disc from the inner spindle, the liquid-dispensing container releases a liquid.

19. The method of claim 18, wherein the liquid is at least one of permanent ink, dye, paint and glue.

20. The method of claim 18, further comprising:
releasing the locking clutch from the pin using a magnetic detacher; and
removing the pin and the liquid-dispensing container from the media disc case.
